(19) United States
(12) Patent Application Publication
(10) Pub. No.: US 2026/0361348 A1
(43) Pub. Date: Nov. 12, 2026

(54) A METHOD OF BEAMFORMING FOR MITIGATING INTERFERENCE BETWEEN NODES OF A WIRELESS COMMUNICATION NETWORK

(71) Applicants: CENTRE OF EXCELLENCE IN WIRELESS TECHNOLOGY, Chennai, Tamil Nadu (IN); INDIAN INSTITUTE OF TECHNOLOGY MADRAS (IIT Madras), Tamil Nadu (IN)

(72) Inventors: Priyanka DEY, Chennai (IN); Deepak Padmanabhan MAYAKUMARI, Chennai (IN); Abhijeet Abhimanyu MASAL, Chennai (IN); Deepak AGARWAL, Chennai (IN); Jeniston Deviraj KLUTTO MILLETH, Chennai (IN); Bhaskar RAMAMURTHI, Chennai (IN)

(21) Appl. No.: 18/997,170

(22) PCT Filed: Jul. 17, 2023
(86) PCT No.: PCT/IN2023/050691

§ 371 Date: Jan. 20, 2025

(30) Foreign Application Priority Data
Jul. 19, 2022 (IN) 202241041376

(51) Int. Cl. H04B 7/0456; H04B 7/06; H04B 17/345; H04W 24/10

(52) U.S. Cl. CPC H04B 7/0456; H04B 7/06952; H04B 17/345; H04W 24/10

(57) ABSTRACT

A method of beamforming for mitigating interference in a wireless communication network is described. The method comprises receiving, by at least one first node, at least one configuration related to Cross Link Interference (CLI). The at least one configuration related to CLI comprises information related to at least one beam for performing at least one of CLI measurement and CLI reporting. The at least one first node receives at least one Cross Link Interference-Reference Signal (CLI-RS) using the at least one beam. The at least one first node measures at least one CLI from at least one third node based on the at least one CLI-RS. The at least one first node further transmits at least one CLI report based on the at least one CLI from the at least one third node.

### CROSS-REFERENCE TO RELATED APPLICATIONS

This application claims the benefit of Indian Patent Application No. 202241041376, filed 19 Jul. 2022 the disclosure of which is incorporated herein by reference in its entirety.

### FIELD OF THE DISCLOSURE

The present disclosure relates to wireless communication networks, and more particularly to a method of beamforming for mitigating interference between nodes of a wireless communication network.

### BACKGROUND OF THE DISCLOSURE

In 5G networks, multiple Base Stations (BS) and multiple User Equipment (UE) may be dispersed across a wireless communication network. In one scenario, two adjacent base stations (BS 1 and BS 2) performs downlink (DL) and uplink (UL) operations, respectively at the same time. For example, a first UE (UE 1) receives DL from a first BS (BS 1) and a second UE (UE 2) transmits UL to a second BS (BS 2). A DL signal from the BS 1 interferes with the reception of a UL signal at the BS 2. The interference caused between the BS 1 and the BS 2 is termed as BS-to-BS Cross Link Interference (CLI). The UE 2 transmits the UL signal in a beam which is directed towards the BS 2. However, due to the presence of sidelobes, the signal transmitted from UE 2 is radiated in other directions. Therefore, the received DL signal at the UE 1 from the BS 1 is interfered by the transmitted UL signal from the UE 2 to the BS 2. The interference caused between the UE 1 and the UE 2 is termed as UE-to-UE CLI. The UE 2 transmitting the UL signal is termed as an aggressor UE and the UE 1 receiving the interference signal is termed as a victim UE.

In another scenario, the UE-to-UE CLI occurs when the victim UE (UE 1) and the aggressor UE (UE 2) are served by a single BS and the BS performs the UL and the DL simultaneously. The BS is capable of full duplexing to perform the UL and the DL in the same time-frequency resources. Alternatively, the BS is capable of sub band full duplexing to perform the UL and the DL at the same time but different frequency resources within the same band. In this case, the BS may perform the DL with the UE 1 and may receive the UL from the UE 2 in the same cell. The UE 2 performing the UL may interfere with the UE 1receiving the DL and results in creating the UE-to-UE CLI in the network. The UE-to-UE CLI at the victim UE may degrade the performance of the victim UE. Hence, there is a need for managing the CLI.

Release 16 of the New Radio (NR) specification has proposed management techniques for the UE-to-UE CLI. Release 16 deals with the measurement of CLI by the victim UE and reporting the measured CLI to its serving BS. However, Release 16 has not defined the behavior of the aggressor UE after the measurement and reporting of CLI in the specification.

In the aforementioned scenario, the UE-to-UE CLI is minimized if the UE 2 forms a null in a direction of the UE 1 while transmitting the UL signal to the BS 2. The UE 2 forms the null in the direction of the UE 1 if the location and/or direction of the UE 1 is known by the UE 2. If the location and/or direction of the UE 1 is known at the BS 2, then BS 2 may also find out a null forming pre-coder for the UE 2 and inform it to the UE 2 to minimize UE-to-UE CLI. The method of optimum beamforming ensures that the transmitter actively operates to minimize the UE-to-UE CLI. For example, the victim UE may be a legacy Release 15 UE which may not be capable of measuring and reporting of the CLI. In this case, if the serving BS of the aggressor UE can acquire information regarding the location of the victim UE from its serving BS, null forming at the aggressor UE may be performed. The serving BS of the victim UE identifies a UE as the victim UE based on interference experienced by a cell edge UE. The aggressor UE may be a legacy Release 15 UE. The serving BS of the aggressor UE obtains the information about the victim UE and informs an optimum beamforming pre-coder to the aggressor UE. When the legacy UE is already capable of receiving information on pre-coders, the serving BS transmits the optimum beamforming pre-coder to the legacy UE without any new signaling. Thus, any aggressor UE in the network is configured to perform an optimum beamforming to minimize CLI. To enable such method, new techniques and signaling exchanges among the aggressor UE, the victim UE, and their serving BSs need to be defined since the existing Release 16 techniques is not sufficient.

There is a need of a method to implement optimum beamforming and exchange signal information in a wireless communication network for managing the UE-to-UE CLI.

### OBJECTS OF THE DISCLOSURE

A general objective of the present disclosure is to define techniques of signal exchanging between the nodes of the wireless communication network.

Another objective of the present disclosure is to provide a method of beamforming for mitigating cross link interference between nodes of a wireless communication network.

### SUMMARY OF THE DISCLOSURE

The summary is provided to introduce aspects related to channel bandwidth adaptation in a cellular network, and the aspects are further described below in the detailed description. This summary is not intended to identify essential features of the claimed subject matter nor is it intended for use in determining or limiting the scope of the claimed subject matter.

In one embodiment, method of mitigating interference in a wireless communication network is described. The method comprises receiving, by at least one first node from at least one second node, at least one configuration related to Cross Link Interference (CLI). The at least one configuration related to CLI comprises information related to at least one beam for performing at least one of CLI measurement and CLI reporting. The method further comprises receiving, by the at least one first node, at least one Cross Link Interference-Reference Signal (CLI-RS) using the at least one beam. The method further comprises measuring, by the at least one first node, at least one CLI from at least one third node based on the at least one CLI-RS.

In one aspect, the method further comprises transmitting, by at least one first node to the at least one second node, at least one CLI report based on the at least one CLI from the at least one third node.

In one aspect, the at least one CLI-RS is a Sounding Reference Signal (SRS).

In one aspect, measuring the at least one CLI comprises measuring at least one CLI metric. The at least one CLI metric is at least one of Reference Signal Received Power (RSRP), Reference Signal Strength Indicator (RSSI), and Reference Signal Received Quality (RSRQ).

In one aspect, receiving the at least one configuration related to CLI comprises receiving a threshold value from the at least one second node.

In one aspect, the method further comprises determining at least one CLI metric and transmitting the at least one CLI report when the at least one CLI metric is above the threshold value.

In one aspect, measuring the at least one CLI comprises measuring at least one of Direction of Arrival (DoA) and identifying the at least one beam based on the at least one CLI-RS.

In one aspect, measuring the DoA further comprises determining a reference for calculation of the DoA, wherein the reference is one of at least one beam predefined in the specification, received from the at least one second node, and determined by the at least one first node.

In one aspect, determining the reference for calculation of the DoA further comprises transmitting the reference to the at least one second node.

In one aspect, the reference comprises a beam corresponding to at least one of Synchronization Signal Block (SSB) through which the at least one first node is latched with the at least one second node and a Beam Identity (ID) corresponding to the at least one Channel State Information-Reference Signal (CSI-RS).

In one aspect, measuring the DoA of the at least one CLI-RS further comprises: obtaining at least one information using at least one past CLI measurement; and improving accuracy of the measurement of the DoA using the at least one information.

In one aspect, measuring the DoA of the at least one CLI-RS comprises measuring the DoA when at least one CLI metric is greater than a threshold value.

In one aspect, measuring the DoA of the at least one CLI-RS further comprises receiving a location information from the at least one second node, wherein the location information corresponds to a node transmitting the at least one CLI-RS.

In one aspect, receiving the at least one configuration related to CLI further comprises receiving one of at least one beam Identity (ID), at least one angular area of coverage, and at least one direction of a beam.

In one aspect, receiving one of the at least one angular area of coverage, and the at least one direction of the beam comprises receiving a reference used for calculation of one of the at least one angular area of coverage and the at least one direction of the beam.

In one aspect, receiving the at least one angular area of coverage further comprises receiving number of beams to cover the at least one angular area of coverage.

In one aspect, receiving the number of beams further comprises receiving at least one of a beam angle, a beam width, and a beam ID to the at least one beam in the at least one angular area of coverage.

In one aspect, the method further comprises receiving, by the at least one first node, a configuration to compute a null forming pre-coder on the at least one CLI-RS for minimizing the at least one CLI; and computing, by the at least one first node, the null forming pre-coder.

In one aspect, the null forming pre-coder is computed when the at least one CLI is greater than a threshold value.

In one aspect, the at least one CLI report comprises at least one of a RSSI, a RSRP, a RSRQ, a DoA, a direction in terms of beam, and a null forming pre-coder.

In one aspect, receiving the at least one configuration related to CLI further comprises receiving a reception time window for the reception of the at least one CLI-RS.

In one embodiment, a method of managing interference between nodes of a wireless communication network is described. The method comprises receiving, by at least one first node, at least one configuration related to Cross Link Interference (CLI); receiving, by the at least one first node, at least one first Cross Link Interference-Reference Signal (CLI-RS); computing, by the at least one first node, at least one CLI metric using the at least one first CLI-RS; and transmitting, by the at least one first node, at least one second CLI-RS based on the at least one CLI metric.

In one aspect, receiving the at least one configuration related to CLI comprises receiving a configuration to transmit the at least one second CLI-RS.

In one aspect, the at least one second CLI-RS is transmitted when the at least one CLI metric is greater than a threshold value.

In one aspect, receiving the configuration to transmit the at least one second CLI-RS comprises receiving at least one of a transmission time window and a transmit beam configuration for the transmission of the at least one second CLI-RS.

In one aspect, the at least one first CLI-RS and the at least one second CLI-RS utilize at least one of same frequency resource and same sequence Identity (ID).

In one aspect, transmitting the at least one second CLI-RS comprises selecting at least one second CLI-RS sequence selected from a plurality of sequences based on a unique ID.

In one aspect, the plurality of sequences is one of pre-defined in the standards and received from at least one second node.

In one embodiment, a method of transmitting a Cross Link Interference-Reference Signal (CLI-RS) in a wireless communication network is described. The method comprises receiving, by at least one first node, a transmit beam configuration information; obtaining, by the at least one first node, at least one beam from the transmit beam configuration information; and transmitting, by the at least one first node, at least one CLI-RS using the at least one beam.

In one aspect, the method further comprises receiving, by the at least one first node, at least one of a first precoder, a location of at least one second node, a Direction of Arrival (DoA), and a second precoder, wherein the second precoder is a null forming pre-coder.

In one aspect, the method further comprises determining by the at least one first node a first precoder based on at least one of a location of at least one second node, a DoA and a second pre-coder. The second precoder is a null forming pre-coder.

In one embodiment, a method of mitigating interference in a wireless communication network is described. The method comprises transmitting, by at least one second node, at least one configuration related to Cross Link Interference (CLI), wherein the at least one configuration related to CLI comprises information related to at least one beam for performing at least one of CLI measurement and CLI reporting; and receiving, by at least one second node, at least one CLI report from at least one first node. The at least one CLI report is determined based on the at least one CLI from at least third node.

In one aspect, transmitting the at least one configuration related to CLI further comprises transmitting a parameter to measure the at least one CLI. The parameter is at least one of Reference Signal Received Power (RSRP), Reference Signal Strength Indicator (RSSI), Reference Signal Received Quality (RSRQ), direction in terms of beam, Direction of Arrival (DoA), and a null forming pre-coder.

In one aspect, the method further comprises transmitting, by at least one second node, a reference for measuring the DoA.

In one aspect, transmitting the at least one configuration related to CLI further comprises transmitting a threshold value.

In one aspect, the method further comprises: transmitting a threshold value; and indicating the at least one first node to measure at least one of the DoA and the null forming pre-coder when at least one of the RSRP, RSSI and RSRQ is above the threshold value.

In one aspect, the method further comprises transmitting, by the at least one second node, a request message for acquiring location information of the at least one third node; and receiving, by the at least one second node, a location information of the at least one third node.

In one aspect, the method further comprises transmitting, by the at least one second node, the location information to the at least one first node.

In one aspect, transmitting the at least one configuration related to CLI further comprises transmitting one of at least one beam Identity (ID), at least one angular area of coverage, and at least one direction of a beam.

In one aspect, the method further comprises transmitting a reference for computing at least one of the at least one angular area of coverage and the at least one direction of a beam.

In one aspect, transmitting the at least one angular area of coverage further comprises transmitting number of beams to cover the at least one angular area of coverage.

In one aspect, transmitting the number of beams further comprises transmitting at least one of a beam angle, a beam width, and a beam ID to the at least one beam in the at least one angular area of coverage.

In one aspect, receiving the at least one CLI report comprises receiving at least one of Reference Signal Received Power (RSRP), Reference Signal Strength Indicator (RSSI), Reference Signal Received Quality (RSRQ), a direction in terms of beam, a Direction of Arrival (DoA), and a null forming pre-coder.

In one aspect, the method further comprises transmitting, by the at least one second node, at least one of DoA, a location information of the at least one first node, and a null forming pre-coder.

In one aspect, transmitting the at least one configuration related to CLI further comprising transmitting a reception time window for performing CLI measurement.

In one aspect, transmitting the at least one configuration related to CLI comprises transmitting at least one of a transmission time window to transmit at least one CLI-RS, a transmit beam configuration to transmit the at least one CLI-RS, at least one sequence for generation of the at least one CLI-RS, a threshold value, and an indication to transmit the CLI-RS when at least one CLI metric is greater than the threshold value.

In one embodiment, a method of mitigating interference in a wireless communication network. The method comprises receiving, by at least one second node, at least one of Direction of Arrival (DoA), a location information of the at least one first node, and a null forming pre-coder; and transmitting, by the at least one second node, at least one of the DoA, the location information of the at least one first node, the null forming pre-coder, and an optimum pre-coder.

In one aspect, the method further comprises determining the optimum pre-coder based on at least one of the DoA, the location information of the at least one first node, and the null forming pre-coder.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a network diagram of a wireless communication network comprising different nodes, in accordance with an embodiment of the present disclosure.

FIG. 2 illustrates a flow chart of a method of beamforming for mitigating interference between a victim UE and an aggressor UE, in accordance with an embodiment of the present disclosure.

FIG. 3 illustrates a signaling diagram for mitigating interference between the aggressor UE and the victim UE, in accordance with an embodiment of the present disclosure.

FIG. 4 illustrates a network diagram of the wireless communication network comprising different nodes, in accordance with an embodiment of the present disclosure.

FIG. 5 illustrates a flow chart of a method of managing interference between nodes of a wireless communication network, in accordance with an embodiment of the present disclosure.

FIG. 6 illustrates a signaling diagram for transmission of the CLI-RS from the victim UE to the aggressor UE, in accordance with an embodiment of the present disclosure.

FIG. 7 illustrates a flow chart of a method of transmitting a Cross Link

Interference-Reference Signal (CLI-RS) a wireless communication network, in accordance with an embodiment of the present disclosure.

FIG. 8 illustrates a flow chart of a method of mitigating interference in a wireless communication network, in accordance with an embodiment of the present disclosure.

FIG. 9 illustrates a flow chart of a method of mitigating interference in a wireless communication network, in accordance with an embodiment of the present disclosure.

### DETAILED DESCRIPTION OF THE DISCLOSURE

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

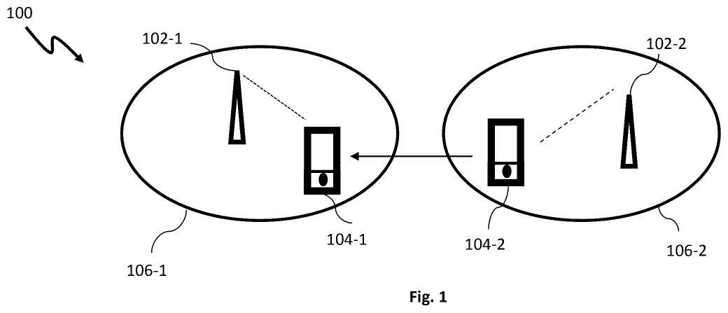

FIG. 1 illustrates a network diagram of a wireless communication network 100 comprising different nodes, in accordance with an embodiment of the present disclosure. The wireless communication network comprises Base Stations (BSs) such as a first BS 102-1 and a second BS 102-2 and User Equipments (UEs), such as first UE 104-1 and second UE 104-2. The first UE 104-1 (also referred as a victim UE 104-1) may be interfered from the second 104-2 (also referred as an aggressor UE 104-2). The victim UE 104-1 may be served by the first BS 102-1 and the aggressor UE 104-2 may be served by the second BS 102-2. The victim UE 104-1 and the aggressor UE 104-2 may be either stationary or mobile and may be dispersed throughout the wireless communication network 100. The wireless communication network 100 may be divided into regions 106-1 and 106-2. The victim UE 104-1 and the first BS 102-1 may lie in the region 106-1 and the aggressor UE 104-2 and the second BS 102-2 may lie in the region 106-2. The first BS 102-1 may transmit a Downlink (DL) signal to the victim UE 104-1 and the second BS 102-2 may receive an Uplink (UL) signal from the aggressor UE 104-2, simultaneously. In such scenario, a Cross Link Interference (CLI) may be occurred from the aggressor UE 104-2 to the victim UE 104-1.

The present disclosure relates to a method of beamforming and exchanging signaling information for mitigating the CLI between nodes, such as the victim UE 104-1 and the aggressor UE 104-2 of the wireless communication network 100. The second BS 102-2 may configure the aggressor UE 104-2 to transmit a CLI Reference Signal (CLI-RS) for CLI measurement. As illustrated in FIG. 1, the aggressor UE 104-2 may transmit the CLI-RS to the victim UE 104-1.

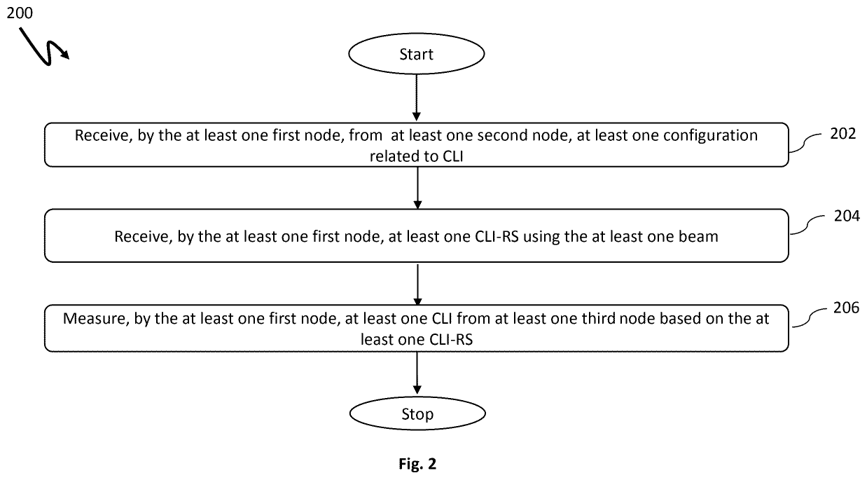

FIG. 2 illustrates a flow chart 200 of a method of beamforming for mitigating interference between the victim UE 104-1 and the aggressor UE 104-2, in accordance with an embodiment of the present disclosure. It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The victim UE 104-1 may receive at least one configuration related to Cross Link Interference (CLI), at step 202. The victim UE 104-1 may be served by the first BS 102-1. The at least one configuration may be received from the first BS 102-1. The at least one configuration may be defined for measuring CLI between the victim UE 104-1 and the aggressor UE 104-2. For example, the at least one configuration may comprise information related to at least one beam for performing at least one of CLI measurement and CLI reporting. The victim UE 104-1 may further receive at least one CLI-RS using the at least one beam, at step 204. The CLI-RS may be a Sounding Reference Signal (SRS). The victim UE 104-1 may measure at least one CLI from the aggressor UE 104-2 based on the CLI-RS, at step 206. Further, the victim UE 104-1 may transmit at least one CLI report based on the at least one CLI from the aggressor UE 104-2.

In one embodiment, the second BS 102-2 may transmit a CLI-RS transmission configuration information to at least one of the first BS 102-1 and the aggressor UE 104-2. The CLI-RS transmission configuration information may be same as a CLI-RS reception configuration information. The second BS 102-2 may transmit a transmit beam configuration information to the aggressor UE 104-2 to perform beam sweeping during transmission of the CLI-RS. The aggressor UE 104-2 may transmit the SRS using a beam which may be directed towards the second BS 102-2. The SRS may interfere at the victim UE 104-1 with a significant strength due to presence of sidelobes. The first BS 102-1 may configure the victim UE 104-1 to receive the SRS transmitted from the aggressor UE 104-2 and measure the CLI. The CLI may be measured by the victim UE 104-1 in terms of a CLI metric such as, Reference Signal Received Power (RSRP), Reference Signal Strength Indicator (RSSI), and Reference Signal Received Quality (RSRQ).

The first BS 102-1 may provide the CLI-RS configuration to the victim UE 104-1. The CLI-RS configuration may include configuration for measurement of the CLI metric and a threshold value. The victim UE 104-1 may measure the CLI metric. The CLI report may be transmitted when the CLI metric is greater than the threshold value.

In one embodiment, the first BS 102-1 may configure the victim UE 104-1 to measure the Direction of Arrival (DoA) of the CLI-RS received from the aggressor UE 104-2. The DoA may be measured in terms of an angle with respect to a reference. The reference may be a reference beam provided by the first BS 102-1 to the victim UE 104-1. The reference beam may comprise at least one of Synchronization Signal Block (SSB) beam through which the victim UE 104-1 is latched with the first BS 102-1 and a beam Identity (ID) corresponding to the at least one Channel State Information-Reference Signal (CSI-RS). The victim UE 104-1 and the first BS 102-1 may have a common knowledge of the reference beam. In one implementation, the reference beam may be defined in the specification/standards. In another implementation, the reference beam may be provided by the first BS 102-1 to the victim UE 104-1. In yet another implementation, the reference beam may be provided by the victim UE 104-1 to the first BS 102-1 based on a measurement as configured by the first BS 102-1.

In one aspect, an information from previous CLI measurement may be used to improve accuracy of measurement of the DoA. If the victim UE 104-1 has performed a previous CLI measurement, then information regarding the identity of the aggressor UE 104-2 may be available to the first BS 102-1. The first BS 102-1 may request the second BS 102-2 to provide location of the aggressor UE 104-2. The second BS 102-2 may forward a location information of the aggressor UE 104-2 to the first BS 102-1. The first BS 102-1 may forward the location information to the victim UE 104-1. The victim UE 104-1 may use the location information to accurately measure of the DoA. The victim UE 104-1 may report the DoA to the first BS 102-1. In one implementation, the first BS 102-1 may configure a threshold value to the victim UE 104-1 to perform DoA measurement only when the CLI metric goes above the threshold value.

In another embodiment, the first BS 102-1 may configure the victim UE 104-1 perform beam sweeping while receiving the CLI-RS. The beam sweeping may be performed to obtain information related to a direction of an incoming signal in terms of beam. In one aspect, the first BS 102-1 may configure the victim UE 104-1 to measure the CLI-RS using defined beams for reception. The first BS 102-1 may restrict the beam sweeping at the victim UE 104-1 to a particular direction based on prior knowledge about the aggressor UE 104-2. The first BS 102-1 may determine an approximate location of the aggressor UE 104-2 based on the prior knowledge of location and coverage area of the first BS 102-2. The first BS 102-1 may configure the victim UE 104-1 to perform the beam sweeping in the direction of the approximate location of aggressor UE 104-2.

The first BS 102-1 may provide a receive beam configuration information to the victim UE 104-1. The receive beam configuration information may comprise at least one of a beam Identity (ID), an angular area of coverage, and an angle of the beam. The first BS 102-1 may configure the angular area of coverage and the angle of the beam with respect to a reference beam. The first BS 102-1 may assign the reference beam to the victim UE 104-1. The reference beam may be the CSI-RS beam transmitted by the first BS 102-1. The first BS 102-1 may provide the angular area with respect to the reference beam to the victim UE 104-1 to perform beam sweeping. When the beam configuration information is angular area of coverage, the first BS 102-1 may provide granularity of beams in terms of number of beams to cover the angular area of coverage. The first BS 102-1 may provide at least one of a beam angle, a beam width and a beam ID to each beam in the angular area.

In one aspect, the first BS 102-1 may provide an information related to an angle of the beam with respect to the reference beam to the victim UE 104-1 to perform the beam sweeping. The first BS 102-1 may provide multiple beam angles and beam-width to the victim UE 104-1 and may assign a beam ID to each beam in the angular area.

The victim UE 104-1 may perform the beam sweeping as configured by the first BS 102-1. The victim UE 104-1 may measure the CLI-RS on each beam and may report the measured CLI of at least one beam to the first BS 102-1. For example, the victim UE 104-1 may report measurements on a subset of beams for which the CLI metric may be the strongest or above the threshold value. The victim UE 104-1 may calculate the DoA based on the angle between the reference beam and the beam or the subset of beams for which the CLI metric may be the strongest or above the threshold value. The victim UE 104-1 may report the DoA to the first BS 102-1.

In one embodiment, the first BS 102-1 may configure the victim UE 104-1 to calculate a null forming pre-coder on the CLI-RS received from the aggressor UE 104-2. The victim UE 104-1 may receive a configuration to calculate the null forming pre-coder on the CLI-RS for minimizing the CLI. The null forming pre-coder may be multiplied with the UL signal transmitted by the aggressor UE 104-2 to minimize the strength of the CLI in the direction of the victim UE 104-1. The victim UE 104-1 may estimate a channel received from the CLI-RS and reconstruct the CLI-RS transmitted by the aggressor UE 104-2 by multiplying the channel with each pre-coder (P) from a codebook and a CLI-RS sequence (X). The victim UE 104-1 may calculate a signal strength of each reconstructed CLI-RS. The victim UE 104-1 may determine the pre-coder having minimum strength for the reconstructed CLI-RS as the null forming pre-coder. The victim UE 104-1 may calculate the null forming pre-coder when the CLI metric goes above the threshold value. The victim UE 104-1 may report the calculated DoA, direction in terms of beam and/or the null forming pre-coder to the first BS 102-1. The CLI report may comprise at least one of the RSSI, the RSRP, the RSRQ, the DoA and the null forming pre-coder. The first BS 102-1 may forward the measured CLI to the second BS 102-2. The at least one configuration related to CLI may further comprise a reception time window for the reception of the at least one CLI-RS.

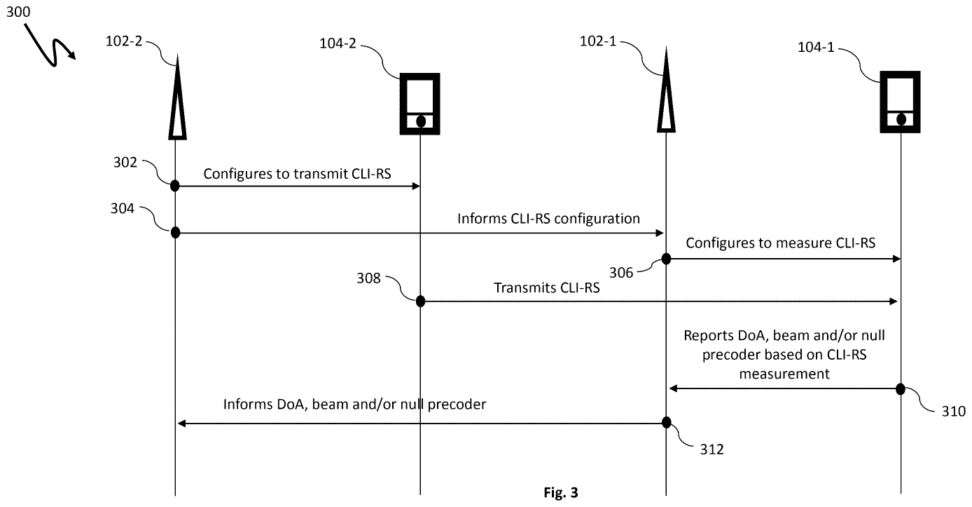

FIG. 3 illustrates a signaling diagram 300 for mitigating interference between the aggressor UE 104-2 and the victim UE 104-1, in accordance with an embodiment of the present disclosure. The second BS 102-2 may configure the aggressor UE 104-2 to transmit the CLI-RS, at step 302. The second BS 102-2 may transmit the CLI-RS configuration to the first BS 102-1, at step 304. The first BS 102-1 may transmit the received CLI-RS configuration to the victim UE 104-1 to measure the CLI-RS, at step 306. The aggressor 104-2 may transmit the CLI-RS to the victim UE 104-1, at step 308. The victim UE 104-1 may measure one or more parameters, such as DoA, a direction in terms of beam, and a null forming pre-coder on the received CLI-RS. The victim UE 104-1 may report the measurement to the first BS 102-1, at step 310. The first BS 102-1 may forward the measurement to the second BS 102-2, at step 312.

In one embodiment, the first BS 102-1 may provide the location of the victim UE 104-1 to the second BS 102-2, if the victim UE 104-1 reports the CLI metric above the threshold value. The second BS 102-2 may use the DoA, the direction in terms of beam, the null forming pre-coder and/or the location of the victim UE 104-1 to find an optimum pre-coder for the aggressor UE 104-2. The second BS 102-2 may transmit details about the optimum pre-coder to the aggressor UE 104-2. The optimum pre-coder may ensure that the strength of the UL signal from the aggressor UE 104-2 is maximized in the direction of the second BS 102-2 and minimized in the direction of the victim UE 104-1.

In one aspect, the second BS 102-2 may transmit the DoA, the direction in terms of beam, the null forming pre-coder and/or the location of the victim UE 104-1 to the aggressor UE 104-2. The aggressor UE 104-2 may calculate the optimum pre-coder based on the DoA, the direction in terms of beam, the null forming pre-coder and/or the location of the victim UE 104-1.

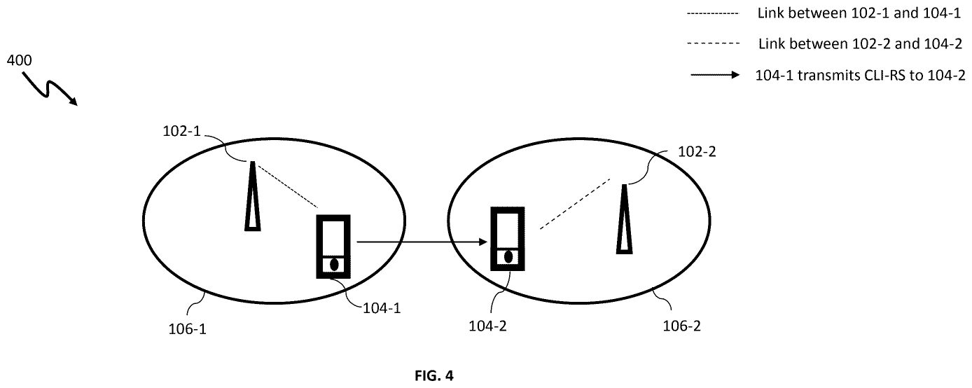

FIG. 4 illustrates a network diagram 400 of the wireless communication network 100 comprising different nodes, in accordance with an embodiment of the present disclosure. The first BS 102-1 may configure the victim UE 104-1 to transmit CLI-RS to the aggressor UE 104-2.

In one aspect, the victim UE 104-1 may measure the CLI from the aggressor UE 104-2. The victim UE 104-1 may report the measured CLI to the first BS 102-1 when the CLI metric is determined to be greater than the threshold value. The first BS 102-1 may configure a transmission window for the victim UE 104-1 to transmit the CLI-RS to the aggressor UE 104-2. The first BS 102-1 may not have the knowledge of the aggressor UE 104-2. The second UE 102-2 may configure a reception window for the aggressor UE 104-2 to monitor if the same CLI-RS is transmitted by any other UE present in the network 100.

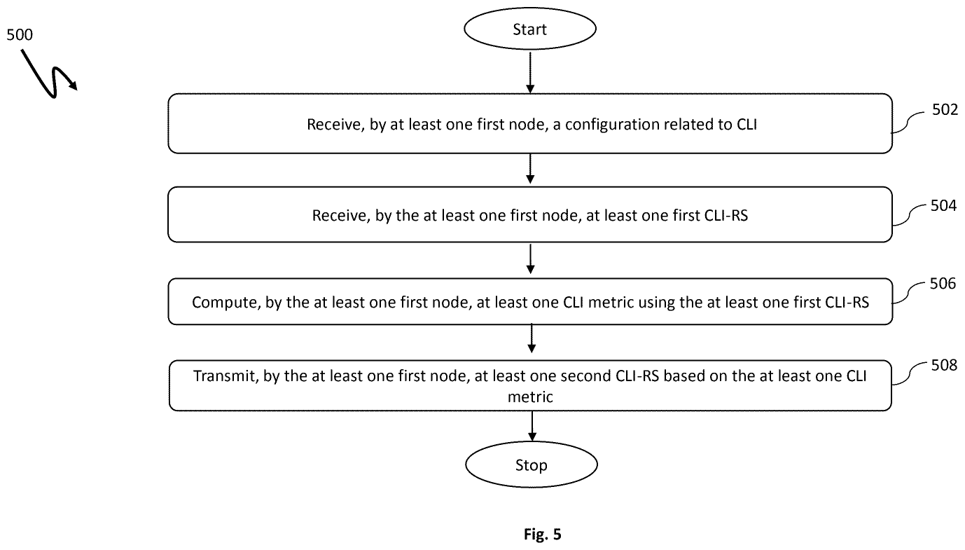

FIG. 5 illustrates a flow chart 500 of a method of beamforming for mitigating interference between nodes of the wireless communication network 100, in accordance with an embodiment of the present disclosure. It should also be noted that in some alternative implementations, the functions noted in the blocks may occur out of the order noted in the drawings. For example, two blocks shown in succession in FIG. 5 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The victim UE 104-1 may receive at least one configuration related to CLI from the first BS 102-1, at step 502. The victim UE 104-1 may further receive first CLI-RStransmitted by the aggressor UE 104-2, at step 504. The victim UE 104-1 may compute at least one CLI metric based on the first CLI-RS, at step 506. The victim UE 104-1 may transmit the second CLI-RS based on the at least one CLI metric, at step 508. The configuration may comprise at least one of a transmission time window and a transmit beam configuration for the transmission of the second CLI-RS.

In one embodiment, the first BS 102-1 may configure the victim UE 104-1 to transmit the second CLI-RS. The first BS 102-1 may configure the victim UE 104-1 to use certain beam forming configuration while transmitting the CLI-RS. The first BS 102-1 may determine the location of the aggressor UE 104-2 based on previous the CLI report. The first BS 102-1 may decide the beam forming configuration at the victim UE 104-1 based on the location of aggressor UE 104-2 and may signal the beam forming configuration to the victim UE 104-1. The aggressor UE 104-2 may receive at least one of a reception time window and a receive beam configuration for the reception of the second CLI-RS. The first CLI-RS and the second CLI-RS may occupy at least one of same frequency resource and same sequence Identity (ID).

In one aspect, the victim UE 104-1 may generate the second CLI-RS sequence based on a unique ID, where the generated sequence is one of a sequence from a plurality of sequences known by the aggressor UE 104-2. The aggressor UE 104-2 may measure the DoA, a direction in terms of beam, and/or null forming pre-coder on the received second CLI-RS. The aggressor UE 104-2 may report the measured CLI to the second BS 102-2. The aggressor UE 104-2 may use the measurement to null form in the direction of the victim UE 104-1 during the UL transmission. The second BS 102-2 may utilize the measured CLI to find an optimum pre-coder for the aggressor UE 104-2. The optimum pre-coder may ensure that the strength of the UL signal from the aggressor UE 104-2 may be maximized in the direction of the second BS 102-2 and may be minimized in the direction of the victim UE 104-1.

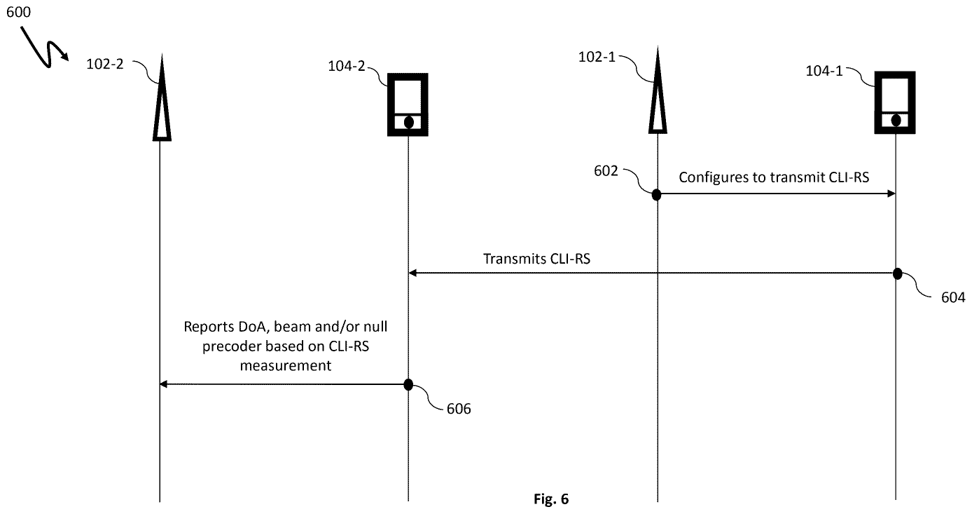

FIG. 6 illustrates a signaling diagram 600 for transmission of the CLI-RS from the victim UE 104-1 to the aggressor UE 104-2, in accordance with an embodiment of the present disclosure. The first BS 102-1 may configure the victim UE 104-1 to transmit the CLI-RS to the aggressor UE 104-2, at step 602. The victim UE 104-1 may transmit the CLI-RS to the aggressor UE 104-2, at step 604. The aggressor UE 104-2 may receive the CLI RS and may measure the DoA, direction in terms of beam and/or null forming pre-coder on the received CLI-RS. The aggressor UE 104-2 may report the measured CLI to the second BS 102-2, at step 606. The aggressor UE 104-2 may use the measured CLI to null form in the direction of the victim UE 104-1.

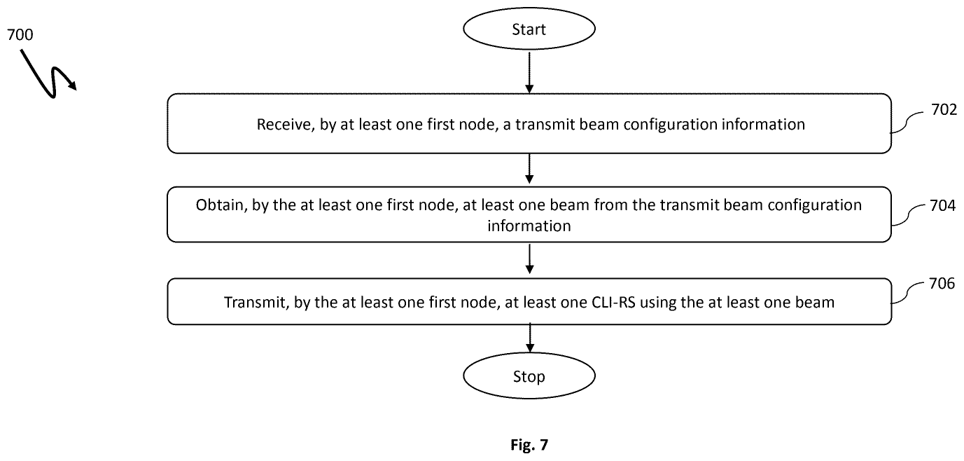

FIG. 7 illustrates a flow chart 700 of a method of transmitting a CLI-RS in the wireless communication network 100, in accordance with an embodiment of the present disclosure. It should also be noted that in some alternative implementations, the functions noted in the blocks may occur out of the order noted in the drawings. For example, two blocks shown in succession in FIG. 7 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The aggressor UE 104-2 may receive a transmit beam configuration information from the second BS 102-2, at step 702. Further, the aggressor UE 104-2 may receive a first precoder, a location of the victim UE 104-1, and a second precoder. The second pre-coder may be a null forming precoder. The aggressor UE 104-2 may obtain at least one beam from the transmit beam configuration information from the second BS 102-2, at step 704. The aggressor UE 104-2 may transmit at least one CLI-RS using the at least one beam, at step 706.

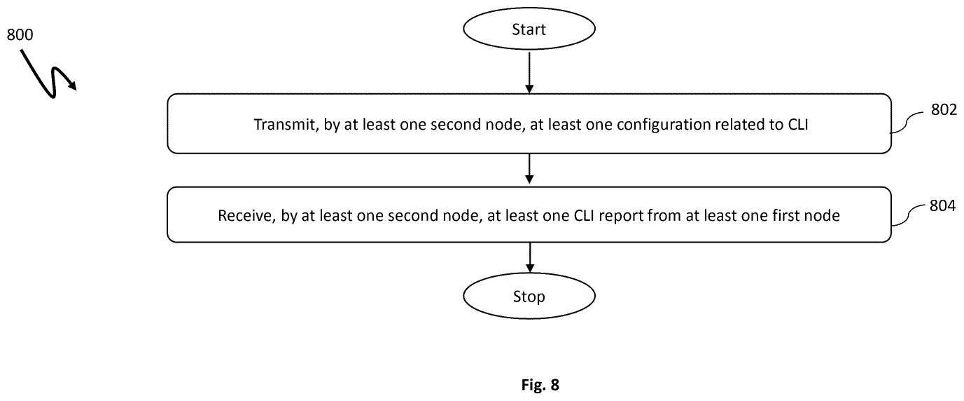

FIG. 8 illustrates a flow chart 800 of a method of mitigating interference in the wireless communication network 100, in accordance with an embodiment of the present disclosure. It should also be noted that in some alternative implementations, the functions noted in the blocks may occur out of the order noted in the drawings. For example, two blocks shown in succession in FIG. 8 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The first BS 102-1 may transmit at least one configuration related to CLI to the victim UE 104-1, at step 802. The at least one configuration related to CLI may comprise information related to at least one beam for performing at least one of CLI measurement and CLI reporting. The information related to CLI may comprise at least one of RSRP, RSSI, RSRQ, direction in terms of beam, DoA, and a null forming pre-coder. For measurement of DoA, the first BS 102-1 may transmit a reference to the victim UE 104-1. Further, the at least one configuration may comprise a threshold value to indicate the victim UE 104-1 to measure the at least one of the DoA and the null forming pre-coder when at least one of the RSRP, RSSI and RSRQ is above the threshold value. The first BS 102-1 may receive at least one CLI report from the victim UE 104-1, at step 804. The at least one CLI report may be determined based on the at least one CLI from at least aggressor UE 104-2. The at least one CLI report may comprise receiving at least one of RSRP, RSSI, RSRQ, a direction in terms of beam, a DoA, and a null forming pre-coder.

The first BS 102-1 may transmit a request message for acquiring location information of the aggressor UE 104-2 and may receive the location information from the aggressor UE 104-2. The location information may be transmitted to the victim UE 104-1 for measuring the CLI from the aggressor UE 104-2.

The first BS 102-1 may further transmit one of at least one beam Identity (ID), at least one angular area of coverage, and at least one direction of a beam to the victim UE 104-1. For example, the first BS 102-1 may transmit number of beams, a beam angle, a beam width, and a beam ID to the at least one beam in the at least one angular area of coverage. In addition, the first BS 102-1 may transmit a reference for computing at least one of the at least one angular area of coverage and the at least one direction of a beam.

The at least one configuration related to CLI may further comprise at least one of a transmission time window to transmit at least one CLI-RS, a transmit beam configuration to transmit the at least one CLI-RS, at least one sequence for generation of the at least one CLI-RS, a threshold value, and an indication to transmit the CLI-RS when at least one CLI metric is greater than the threshold value.

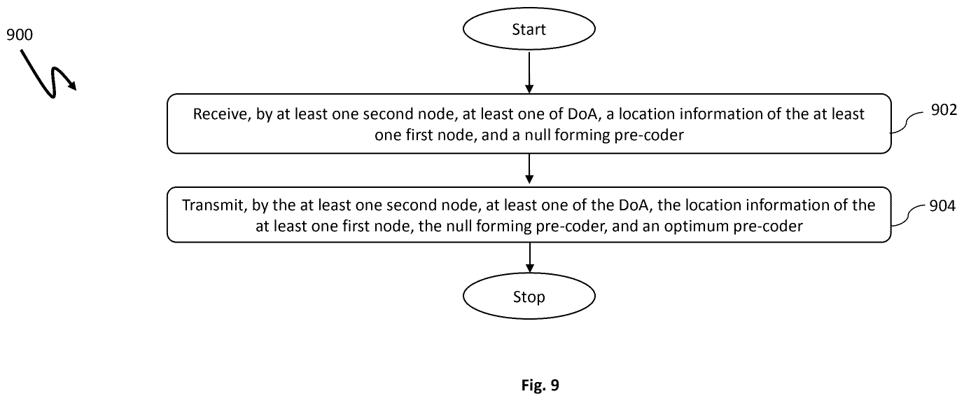

FIG. 9 illustrates a flow chart 900 of a method of mitigating interference in the wireless communication network 100, in accordance with an embodiment of the present disclosure. It should also be noted that in some alternative implementations, the functions noted in the blocks may occur out of the order noted in the drawings. For example, two blocks shown in succession in FIG. 9 may in fact be executed substantially concurrently or the blocks may sometimes be executed in the reverse order, depending upon the functionality involved. Alternate implementations are included within the scope of the example embodiments in which functions may be executed out of order from that shown or discussed, including substantially concurrently or in reverse order, depending on the functionality involved.

The second BS 102-2 receive at least one of Direction of Arrival (DoA), a location information of the victim UE 104-1, and a null forming pre-coder, at step 902. The second BS 102-2 may determine an optimum pre-coder based on at least one of the DoA, the location information, and the null forming pre-coder. The second BS 102-2 may transmit at least one of the DoA, the location information, the null forming pre-coder, and the optimum pre-coder to the aggressor UE 104-2, at step 904.

The present disclosure relates to a method of beamforming and exchanging signaling information for mitigating Cross Link Interference (CLI) between nodes of the wireless communication network 100. The present disclosure also provides optimum pre-coder to minimize the cross link interference between the nodes.

In the above detailed description, reference is made to the accompanying drawings that form a part thereof, and illustrate the best mode presently contemplated for carrying out the disclosure. However, such description should not be considered as any limitation of scope of the present disclosure. The structure thus conceived in the present description is susceptible of numerous modifications and variations, all the details may furthermore be replaced with elements having technical equivalence.

1. A method of mitigating interference in a wireless communication network, the method comprising:
receiving, by at least one first node from at least one second node, at least one configuration related to Cross Link Interference (CLI), wherein the at least one configuration related to CLI comprises information related to at least one beam for performing at least one of CLI measurement and CLI reporting;
receiving, by the at least one first node, at least one Cross Link Interference-Reference Signal (CLI-RS) using the at least one beam; and
measuring, by the at least one first node, at least one CLI from at least one third node (104-2) based on the at least one CLI-RS.

2. The method as claimed in claim 1, further comprises
transmitting, by at least one first node, to the at least one second node, at least one CLI report based on the at least one CLI from the at least one third node.

3. The method as claimed in claim 1, wherein the at least one CLI-RS is a Sounding Reference Signal (SRS).

4. The method as claimed in claim 1, wherein measuring the at least one CLI comprises measuring at least one CLI metric, wherein the at least one CLI metric is at least one of Reference Signal Received Power (RSRP), Reference Signal Strength Indicator (RSSI), and Reference Signal Received Quality (RSRQ).

5. The method as claimed in claim 1, wherein receiving the at least one configuration related to CLI comprises receiving a threshold value from the at least one second node.

6. The method as claimed in claim 4, further comprises:
determining at least one CLI metric; and
transmitting the at least one CLI report when the at least one CLI metric is above the threshold value.

7. The method as claimed in claim 1, wherein measuring the at least one CLI comprises measuring at least one of Direction of Arrival (DoA) and identifying the at least one beam based on the at least one CLI-RS.

8. The method as claimed in claim 7, wherein measuring the DoA further comprises determining a reference for calculation of the DoA, wherein the reference is one of:
at least one beam predefined in the specification,
received from the at least one second node ; and
determined by the at least one first node.

9. The method as claimed in claim 8, wherein determining the reference for calculation of the DoA further comprises transmitting the reference to the at least one second node.

10. The method as claimed in claim 8, wherein the reference comprises a beam corresponding to at least one of Synchronization Signal Block (SSB) through which the at least one first node is latched with the at least one second node and a Beam Identity (ID) corresponding to the at least one Channel State Information-Reference Signal (CSI-RS).

11. The method as claimed in claim 7, wherein measuring the DoA of the at least one CLI-RS further comprises:
obtaining at least one information using at least one past CLI measurement; and
improving accuracy of the measurement of the DoA using the at least one information.

12. The method as claimed in claim 7, wherein measuring the DoA of the at least one CLI-RS comprises measuring the DoA when at least one CLI metric is greater than a threshold value.

13. The method as claimed in claim 7, wherein measuring the DoA of the at least one CLI-RS further comprises receiving a location information from the at least one second node, wherein the location information corresponds to a node transmitting the at least one CLI-RS.

14. The method as claimed in claim 1, wherein receiving the at least one configuration related to CLI further comprises receiving one of at least one beam Identity (ID), at least one angular area of coverage, and at least one direction of a beam.

15. The method as claimed in claim 14, wherein receiving one of the at least one angular area of coverage, and the at least one direction of the beam comprises receiving a reference used for calculation of one of the at least one angular area of coverage and the at least one direction of the beam.

16. The method as claimed in claim 15, wherein receiving the at least one angular area of coverage further comprises receiving number of beams to cover the at least one angular area of coverage.

17. The method as claimed in claim 16, wherein receiving the number of beams further comprises receiving at least one of a beam angle, a beam width, and a beam ID to the at least one beam in the at least one angular area of coverage.

18. The method as claimed in claim 1, further comprises
receiving, by the at least one first node, a configuration to compute a null forming pre-coder on the at least one CLI-RS for minimizing the at least one CLI; and
computing, by the at least one first node, the null forming pre-coder.

19. The method as claimed in claim 18, wherein the null forming pre-coder is computed when the at least one CLI is greater than a threshold value.

20. The method as claimed in claim 2, wherein the at least one CLI report comprises at least one of a RSSI, a RSRP, a RSRQ, a DoA, a direction in terms of beam, and a null forming pre-coder.

21. The method as claimed in claim 1, wherein receiving the at least one configuration related to CLI further comprises receiving a reception time window for the reception of the at least one CLI-RS.

22. A method of managing interference between nodes of a wireless communication network, the method comprising:
receiving, by at least one first node, at least one configuration related to Cross Link Interference (CLI);
receiving, by the at least one first node, at least one first Cross Link Interference-Reference Signal (CLI-RS);
computing, by the at least one first node, at least one CLI metric using the at least one first CLI-RS; and
transmitting, by the at least one first node, at least one second CLI-RS based on the at least one CLI metric.

23. The method as claimed in claim 22, wherein receiving the at least one configuration related to CLI comprises receiving a configuration to transmit the at least one second CLI-RS.

24. The method as claimed in claim 22, wherein the at least one second CLI-RS is transmitted when the at least one CLI metric is greater than a threshold value.

25. The method as claimed in claim 23, wherein receiving the configuration to transmit the at least one second CLI-RS comprises receiving at least one of a transmission time window and a transmit beam configuration for the transmission of the at least one second CLI-RS.

26. The method as claimed in claim 22, wherein the at least one first CLI-RS and the at least one second CLI-RS utilize at least one of same frequency resource and same sequence Identity (ID).

27. The method as claimed in claim 22, wherein transmitting the at least one second CLI-RS comprises selecting at least one second CLI-RS sequence selected from a plurality of sequences based on a unique ID.

28. The method as claimed in claim 27, wherein the plurality of sequences is one of pre-defined in the standards and received from at least one second node.

29. A method of transmitting a Cross Link Interference-Reference Signal (CLI-RS) in a wireless communication network, the method comprising:
receiving, by at least one first node, a transmit beam configuration information;
obtaining, by the at least one first node, at least one beam from the transmit beam configuration information; and
transmitting, by the at least one first node, at least one CLI-RS using the at least one beam.

30. The method as claimed in claim 29, further comprising receiving, by the at least one first node, at least one of a first precoder, a location of at least one second node, a Direction of Arrival (DoA), and a second precoder, wherein the second precoder is a null forming pre-coder.

31. The method as claimed in claim 29, further comprising determining by the at least one first node a first precoder based on at least one of a location of at least one second node, a DoA and a second pre-coder; wherein the second precoder is a null forming pre-coder.

32. A method of mitigating interference in a wireless communication network, the method comprising:
transmitting, by at least one second node, at least one configuration related to Cross Link Interference (CLI), wherein the at least one configuration related to CLI comprises information related to at least one beam for performing at least one of CLI measurement and CLI reporting; and
receiving, by at least one second node, at least one CLI report from at least one first node, wherein the at least one CLI report is determined based on the at least one CLI from at least third node.

33. The method as claimed in claim 32, wherein transmitting the at least one configuration related to CLI further comprises transmitting a parameter to measure the at least one CLI, wherein the parameter is at least one of Reference Signal Received Power (RSRP), Reference Signal Strength Indicator (RSSI), Reference Signal Received Quality (RSRQ), direction in terms of beam, Direction of Arrival (DoA), and a null forming pre-coder.

34. The method as claimed in claim 33, further comprises transmitting, by at least one second node, a reference for measuring the DoA.

35. The method as claimed in claim 32, transmitting the at least one configuration related to CLI further comprises transmitting a threshold value.

36. The method as claimed in claim 32, further comprises:
transmitting a threshold value; and
indicating the at least one first node to measure at least one of the DoA and the null forming pre-coder when at least one of the RSRP, RSSI and RSRQ is above the threshold value.

37. The method as claimed in claim 32, further comprising:
transmitting, by the at least one second node, a request message for acquiring location information of the at least one third node; and
receiving, by the at least one second node, a location information of the at least one third node.

38. The method as claimed in claim 37, further comprises transmitting, by the at least one second node, the location information to the at least one first node.

39. The method as claimed in claim 32, wherein transmitting the at least one configuration related to CLI further comprises transmitting one of at least one beam Identity (ID), at least one angular area of coverage, and at least one direction of a beam.

40. The method as claimed in claim 39, further comprises transmitting a reference for computing at least one of the at least one angular area of coverage and the at least one direction of a beam.

41. The method as claimed in claim 39, wherein transmitting the at least one angular area of coverage further comprises transmitting number of beams to cover the at least one angular area of coverage.

42. The method as claimed in claim 41, wherein transmitting the number of beams further comprises transmitting at least one of a beam angle, a beam width, and a beam ID to the at least one beam in the at least one angular area of coverage.

43. The method as claimed in claim 32, wherein receiving the at least one CLI report comprises receiving at least one of Reference Signal Received Power (RSRP), Reference Signal Strength Indicator (RSSI), Reference Signal Received Quality (RSRQ), a direction in terms of beam, a Direction of Arrival (DoA), and a null forming pre-coder.

44. The method as claimed in claim 32, further comprises transmitting, by the at least one second node, at least one of DoA, a location information of the at least one first node, and a null forming pre-coder.

45. The method as claimed in claim 32, wherein transmitting the at least one configuration related to CLI further comprising transmitting a reception time window for performing CLI measurement.

46. The method as claimed in claim 32, wherein transmitting the at least one configuration related to CLI comprises transmitting at least one of a transmission time window to transmit at least one CLI-RS, a transmit beam configuration to transmit the at least one CLI-RS, at least one sequence for generation of the at least one CLI-RS, a threshold value, and an indication to transmit the CLI-RS when at least one CLI metric is greater than the threshold value.

47. A method of mitigating interference in a wireless communication network, the method comprising:
receiving, by at least one second node, at least one of Direction of Arrival (DoA), a location information of the at least one first node, and a null forming pre-coder; and
transmitting, by the at least one second node, at least one of the DoA, the location information of the at least one first node, the null forming pre-coder, and an optimum pre-coder.

48. The method as claimed in claim 47, further comprises determining the optimum pre-coder based on at least one of the DoA, the location information of the at least one first node, and the null forming pre-coder.
